(19) United States
(12) Patent Application Publication
(10) Pub. No.: US 2002/0066100 A1
(43) Pub. Date: May 30, 2002

(54) Method for providing data services for a large number of small-sized data files

(76) Inventor: Khoi Hoang, Pleasanton, CA (US)

Correspondence Address: Brian R. Coleman, OPPENHEIMER WOLFF & DONNELLY LLP, 1400 Page Mill Road, Palo Alto, CA, 94304, US

(21) Appl. No.: 09/997,954

(22) Filed: Nov. 28, 2001

Related U.S. Application Data
(63) Continuation-in-part of application No. 09/933,696, filed on Aug. 20, 2001.
(63) Continuation-in-part of application No. 09/902,503, filed on Jul. 9, 2001.
(63) Continuation-in-part of application No. 09/892,017, filed on Jun. 25, 2001.
(63) Continuation-in-part of application No. 09/892,015, filed on Jun. 25, 2001.
(63) Continuation-in-part of application No. 09/870,879, filed on May 30, 2001.
(63) Continuation-in-part of application No. 09/584,832, filed on May 31, 2000.
(63) Continuation-in-part of application No. 09/709,948, filed on Nov. 10, 2000.
(63) Continuation-in-part of application No. 09/841,792, filed on Apr. 24, 2001.

(51) Int. Cl. H04N 5/445; G06F 3/00; G06F 13/00; H04N 7/173

(52) U.S. Cl. 725/39; 725/60; 725/86

(57) ABSTRACT

An apparatus for retrieving data files broadcast repetitively over at least a first time interval and a second time interval comprising: means for receiving a file request from a user selecting at least one of the broadcast data files; means for initiating an authorized file retrieval process to retrieve at least a first part of the data file broadcast during the first time interval; means for displaying at least a portion of the first part of the data file during at least a portion of the second time interval; means for retrieving a second part of the data file broadcast during the second time interval; and means for displaying at least a portion of the second part of the data file.

### RELATED APPLICATIONS

This application is a continuation-in-part claiming priority to Khoi Hoang's patent applications entitled A METHOD AND APPARATUS FOR TRANSMITTING NON-VOD SERVICES, filed on Oct. 25, 2001, bearing Attorney Docket Number 60595-301801; SELECTIVE INACTIVATION AND COPY-PROTECTION, filed on Aug. 20, 2001, bearing application Ser. No. 09/933,696, CONTROLLING DATA-ON-DEMAND CLIENT ACCESS, filed on Jul. 9, 2001, bearing application Ser. No. 09/902,503, DECREASED IDLE TIME AND CONSTANT BANDWIDTH DATA-ON-DEMAND BROADCAST DELIVERY MATRICES, filed on Jun. 25, 2001, bearing application Ser. No. 09/892,017, COUNTERFEIT STB PREVENTION THROUGH PROTOCOL SWITCHING, filed on Jun. 25, 2001, bearing application Ser. No. 09/892,015, UNIVERSAL STB ARCHITECTURES AND CONTROL METHODS filed on May 30, 2001, bearing application Ser. No. 09/870,879, NON CLIENT SPECIFIC ON-DEMAND DATA BROADCAST (Amended) filed on May 31, 2000, bearing application Ser. No. 09/584,832, METHODS FOR PROVIDING VIDEO-ON-DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all nine being incorporated herein by reference.

### BRIEF DESCRIPTION OF THE INVENTION

### FIELD OF THE INVENTION

This invention relates generally to data-on-demand (DOD) broadcast systems. In particular, this invention relates to digital DOD broadcast systems for transmitting large numbers of small data files to large numbers of end users.

### BACKGROUND OF THE INVENTION

In the current information age people require rapid access to all entertainment, news, goods and services. Currently there is no service capable of quickly providing a large variety of small data files such as karaoke audio/video files to a large number of individual customers. Though internet web pages offer a wealth of text on various topics they require bi-directional communication and may take a long time to access with existing modem technology. Additionally a typical internet web site can only transmit a typical file to a limited number of recipients.

Prior Art FIG. 1 shows a simplified prior art functional block diagram of a Data On Demand (DOD) system 10. A user at a display screen such as a television 12 makes a selection of an audio/video service (such as a Karaoke music file) listed on an electronic program guide (EPG) and places his order for the audio/video selection using a Set Top Box (STB) 14 coupled to the television 12. The STB 14 is able to communicate to a DOD server 18 via a bi-directional network connection through a wide area network 16 such as the Internet. Once the DOD server 18 receives a request from the user (viewer) 12, the DOD server 18 accesses a bank of disk arrays 20 storing the audio/video selections available in the EPG, and retrieves the selected audio/video file and transmits the selected file to the user over the wide area network. This typical bi-directional distribution infrastructure 16 may consist of any combination of a telephone network and/or a cable TV system. In transmitting the selected file, the video data may be encoded based on any suitable protocol necessary to achieve maximum efficiency for the overall system.

Prior Art FIG. 2 is simplified functional block diagram of a prior art STB 14. STB 14 includes a demodulator 29, a transport stream demux 22, a video decoder 24, an audio decoder 26, and a clock control unit 28. Once the user's request is processed by the DOD server, the corresponding data is transmitted to the user STB 14. A typical prior art STB 14 may channel the incoming transport stream to the demodulator 20 in order to demodulate the incoming signal. The demodulated signal is then separated into its distinct components by the transport stream demux 22. The video data component of the incoming stream is decoded by the video decoder 24 and the audio data component is decoded by the audio decoder 26. The incoming transport stream also provides timing information used by the clock control unit 28. The clock control unit 28 provides a timing output used to correspond or synchronize the video data to the corresponding audio data.

Prior art FIG. 3 is a block diagram of a prior art method 40 for DOD transmission of small data files over a network. In order for the user to select a particular audio/visual selection, an EPG including the available selection and timing must be provided to the user. In step 30, the STB 14 tunes into the appropriate channel and receives the transmitted EPG. Next, in step 32, the STB 14 provides the EPG to the user for viewing. In step 34, the user input is transmitted to a DOD server 18 in the form of a demand for a particular audio/visual selection. The STB 14 then tunes to the appropriate channel or allocated bandwidth in anticipation of receiving the requested data file. In step 38, the client requested data file is received by the STB 14 and provided to the client in the form of displayable images after having demodulated, demultiplexed and decoded the incoming signals. Typically, a prior art system may have download rates of 2 Mb/s to 6 Mb/s. For a DOD file, the download speed has to be fast enough to allow real-time playing of the video.

Typically Karaoke music files are encoded in MPEG format (MPEG-1 or MPEG-2), with bit rates varied from CBR (constant bit rate) 1.5 Mbs to 4 Mbs for VBR such as in DVD format. Music play time can vary from one to several minutes. Assuming an encoded bit rate of 1.5 Mb/s (MPEG-1), the file length for a 3 minute Karaoke song is around 34 Mbytes, much smaller than most movies or other audio/visual files.

There are many limitations of current DOD broadcast systems used to transmit large numbers of small data files. The transmission bandwidth required by conventional DOD server systems is dependent upon the number of DOD users, with large numbers of users requiring proportionally more bandwidth. Conventional DOD server systems require bi-directional communications. Conventional DOD systems cannot play a file at a bit rate greater than the transmission bit rate of the file being downloaded for streaming video.

Existing systems require a broad bandwidth and are limited in the number of clients they can service at one time due primarily to the bandwidth requirements. Furthermore, the transmission methods of the prior art fail to take advantage of the capabilities and processing power of the new STBs that have the intelligence to download files using more flexible and efficient algorithms.

Therefore, what is needed is a DOD broadcast system capable of transmitting a large number of small data files to a large number of clients simultaneously over a narrow bandwidth, without the need for bi-directional communication. Further needed is a more bandwidth efficient method of downloading data files by taking advantage of intelligent STB capabilities such as by processing transmitted data using more complex protocols.

### SUMMARY OF THE INVENTION

The present invention provides a DOD broadcast system capable of transmitting a large number of small data files to a large number of clients simultaneously over a narrow bandwidth, without the need for bi-directional communication. The present invention further provides an STB capable of downloading a data file at a bit rate greater that the data files playing bit rate, allowing data files to be downloaded faster than they can be played. Further provided is a more bandwidth efficient method of downloading data files by taking advantage of intelligent STB capabilities such as by processing transmitted data using more complex protocols.

Briefly, one aspect of the present invention is embodied in an apparatus for retrieving a plurality of data files broadcast repetitively over at least a first time interval and a second time interval comprising: means for receiving at least one file request from a user selecting at least one of the broadcast data files; means for initiating an authorized file retrieval process to retrieve at least a first part of the at least one selected data file broadcast during the first time interval; means for displaying at least a portion of the first part of the at least one data file during at least a portion of the second time interval; means for retrieving a second part of the at least one data file broadcast during the second time interval; and means for displaying at least a portion of the second part of the at least one data file.

Another embodiment of the present invention teaches a method for transmitting a large number of small data files to a large number of customers comprising the acts of: transmitting a plurality of data files to a plurality of users, wherein customers authorized to receive a selected data file may do so, and wherein customers not authorized to receive the selected file are prevented from doing so. The method including transmitting an electronic program guide (EPG) to the plurality of users, wherein the user may select the selected data file using the electronic program guide. Wherein each data files is transmitted repeatedly. Further wherein each data file has an allocated bandwidth, wherein the data files are repeatedly transmitted on a corresponding bandwidth.

In one embodiment of the method an icon corresponding to each data file is displayed via the EPG such that a user may select the data file by selecting the displayed icon. In another embodiment at least one of the plurality of data files is a karaoke music file including audio and visual data.

Alternatively at least one of the plurality of data files is a text file including graphics and a plurality of pages, wherein at least one page contains textual information. A service corresponding to a transaction feature contained in the text file may be activated by the first user.

### BRIEF DESCRIPTION OF THE DRAWINGS

Prior art FIG. 1 is a simplified functional block diagram of a DOD system;

Prior art FIG. 2 is a simplified functional block diagram of a prior art STB;

Prior art FIG. 3 is a block diagram of a prior art method of DOD transmission over a network;

FIG. 4 is a simplified block diagram of a DOD broadcast server according to one embodiment of the present invention;

FIG. 5 is an operational block diagram of a DOD server system in accordance with one embodiment of the present invention;

FIG. 6 is a block diagram of an intelligent set-top-box in accordance with one embodiment of the present invention;

FIG. 7 is a flow chart diagram illustrating a method for downloading data files in accordance with one embodiment of the present invention;

FIG. 7A illustrates an alternative bi-directional authentication process for purchasing selected DOD services in accordance with one embodiment of the present invention;

FIG. 8 is a simplified diagram illustrating data block transmission in accordance with one embodiment of the present invention;

FIG. 9 is a simplified diagram illustrating data block transmission in accordance with an alternative embodiment of the present invention;

FIG. 10 is a flow chart diagram illustrating a text/graphic file download operation in accordance with one embodiment of the present invention; and

FIG. 11 is a flow chart diagram illustrating a text/graphic file transaction in accordance with one embodiment of the present invention.

### DETAILED DESCRIPTION OF THE INVENTION

The present invention provides a DOD broadcast system capable of transmitting a large number of small data files to a large number of clients simultaneously over a narrow bandwidth, without the need for bi-directional communication. The present invention further provides an STB capable of downloading a data file at a bit rate greater that the data files playing bit rate, allowing data files to be downloaded faster than they can be played. This is accomplished by transmitting each small data file on its own allocated bandwidth repeatedly to all existing customers. A customer may access any selected data file with only a short delay using an intelligent STB. The intelligent STB would also restrict a customers access to services the customer was not subscribed to. In this way individual files would not need to be transmitted to individual customers in order to restrict access.

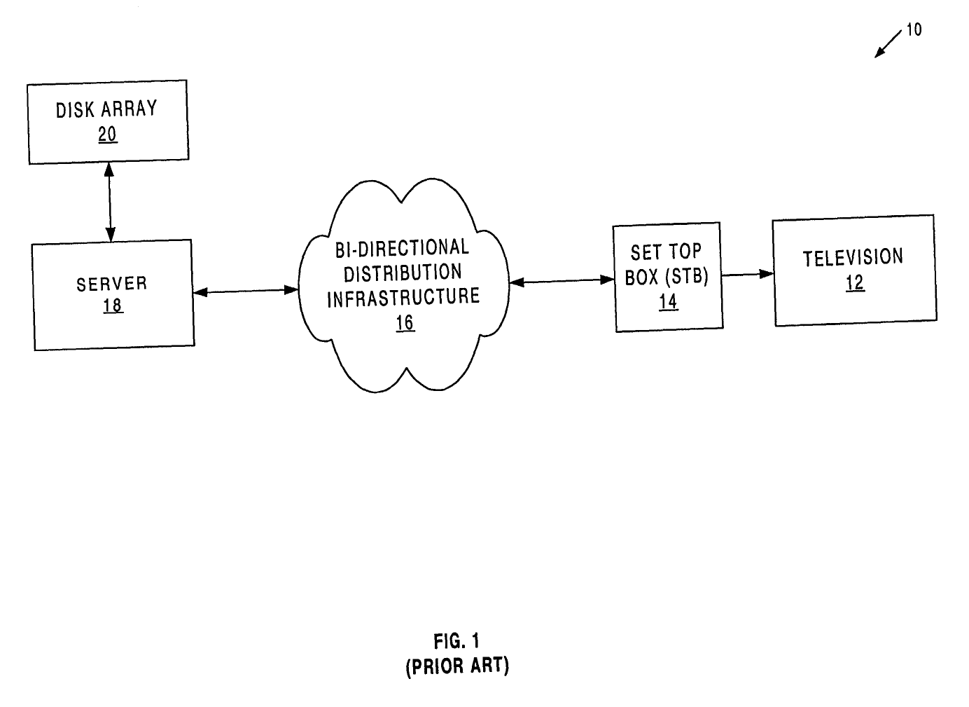

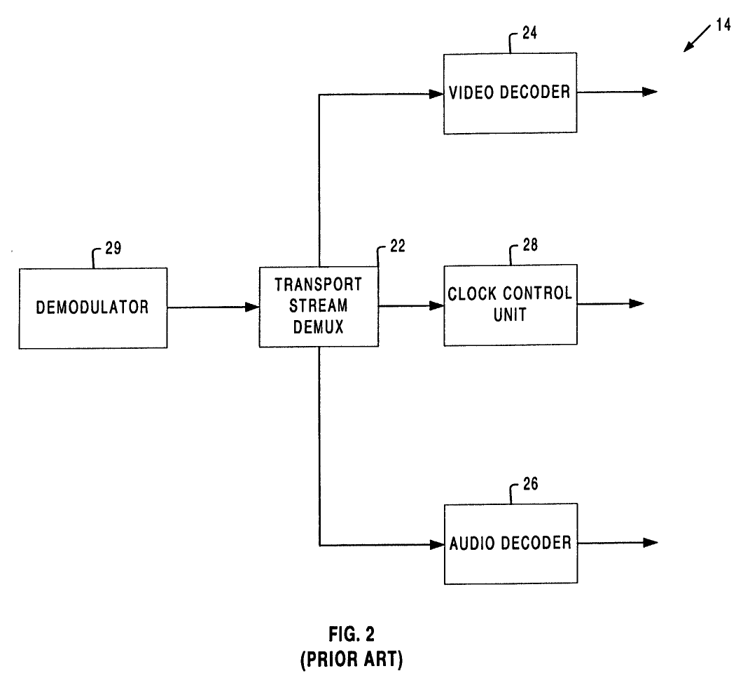

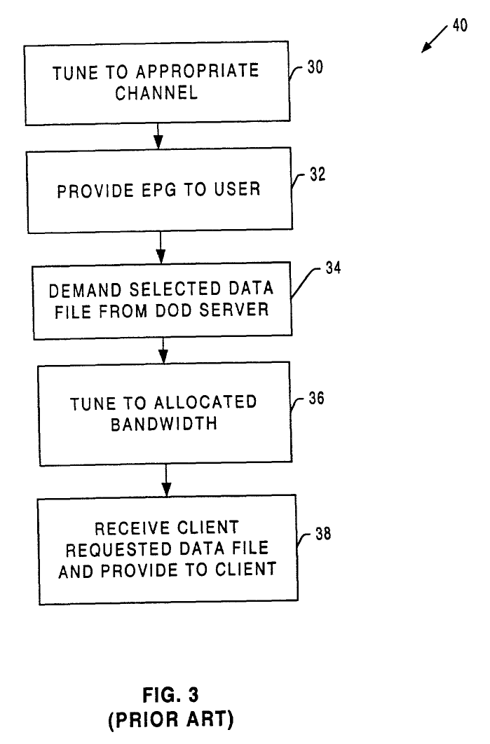

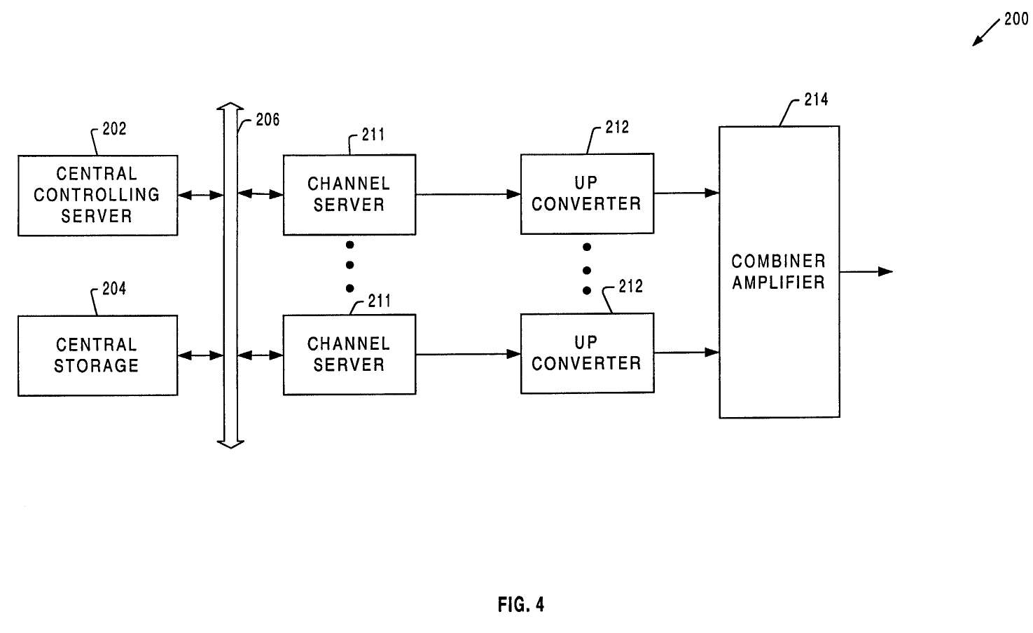

FIG. 4 is a simplified block diagram of a transmission server according to one embodiment of the present invention. The DOD server 200 includes a plurality of channel servers 211, a plurality of up converters 212 each corresponding to a channel server 211, a combiner amplifier 214, a central controlling server 202, and a central storage 204, coupled as illustrated through a data bus 206. As will be described below, the central controlling server 202 controls off-line operation of the channel servers 211, as well as initiating real-time transmission once the channel servers 211 are ready. The central storage 204 typically stores data files in a digital format. However, any suitable mass persistent data storage device may be used.

In an exemplary embodiment, data files stored in the central storage 204 are accessible via a standard network interface (e.g., Ethernet connection) by any authorized computer, such as the central controlling server 202, connected to the network. The channel servers 211 provide data files that are retrieved from the central storage 204 in accordance with instructions from the central controlling server 202. The retrieval of digital data and the scheduling of transmission of the digital data for DOD is performed “off-line” to fully prepare each channel server 211 for real-time data transmission. Each channel server 211 informs the central controlling server 202 when ready to provide DOD, at which point the central controlling server 202 can control the channel servers 211 to begin DOD transmission.

In a preferred embodiment, the central controlling server 202 includes a graphics user interface (not shown) to enable a service provider to schedule data delivery by a drag-and-drop operation. Further, the central controlling server 202 authenticates and controls the channel servers 210 to start or stop according to delivery matrices. Systems and methods for providing uni-directional DOD broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application Ser. No. 09/584,832, which is incorporated herein by reference.

Each channel server 211 is assigned to a channel and is coupled to a receiving up-converter 212. The channel server 211 transmits the DOD information to each up-converter 212. The output of each channel server 211 is a quadrature amplitude modulation (QAM) modulated intermediate frequency (IF) signal having a suitable frequency for the corresponding up-converter 212. The QAM-modulated IF signals are dependent upon adopted standards. The current adopted standard in the United States is the data-over-cable-systems-interface-specification (DOCSIS) standard, which requires an approximately 43.75 MHz IF frequency.

The up-converters 212 convert IF signals received from the channel servers 211 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz.

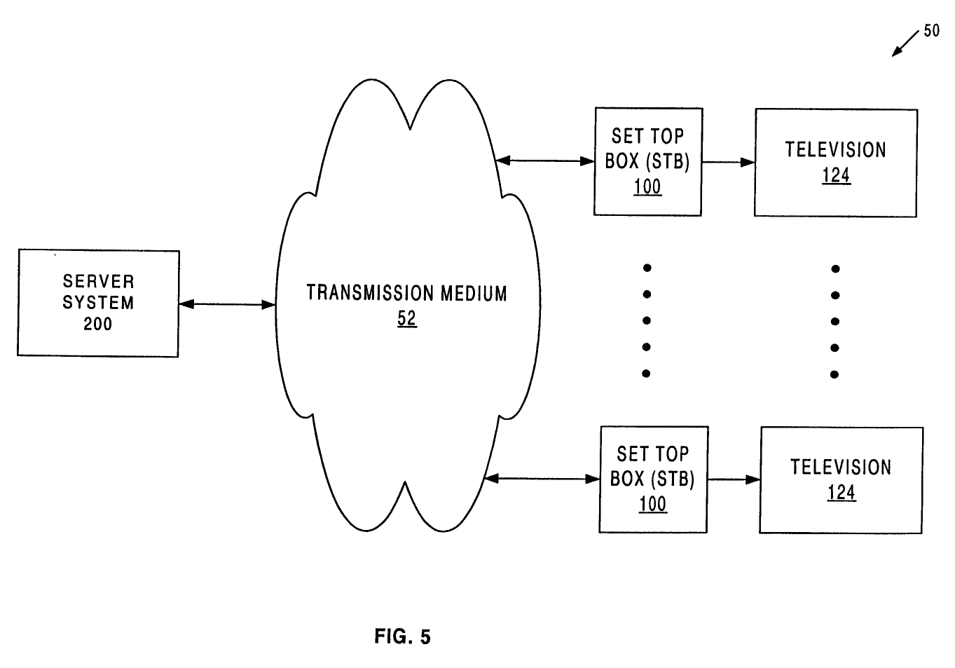

The outputs of the up-converters 212 are applied to the combiner/amplifier 214. The combiner/amplifier 214 amplifies, conditions and combines the received RF signals then outputs the signals out to the data network 52 (FIG. 5). In accordance with one embodiment the data network is a cable television distribution network, or other unidirectional data distribution network.

In an exemplary embodiment 20 broadcast channels are allocated for the transmission of karoake files and other small data files. Typically Karaoke music files are encoded in MPEG format (MPEG-1 or MPEG-2), with bit rates varied from CBR (constant bit rate) 1.5 Mbs to 4 Mbs or VBR such as in DVD format. Music play time can vary from one to several minutes. Assuming an encoded bit rate of 1.5 Mb/s (MPEG-1), the file length for a 3 minute Karaoke song is around 34 Mbytes.

For example, assuming each channel has a usable bandwidth of 36 Mbs (for 8 MHz cable system using QAM64). Each small data file is allocated a 1 Mbs transmission bandwidth. This would allow 36 karaoke files to be transmitted on each channel, and a total of 720 karaoke data files on 20 channels. If a subscriber is authorized to access a typical karaoke file (3 minute play time encoded using MPEG-1) the download time would be approximately 4.5 minutes ((3 min×1.5 Mbs)/1 Mbs). The table below shows an example of the relationship between the bit rate, the allocated bandwidth, the number of small data files to be downloaded and the download time for a typical 3 minute karaoke song.

TABLE 1

| Encoded | Allocated | | |
|---|---|---|---|
| Bit Rate | Bandwidth | Number of | Maximum Download |
| (Mbs) | (MHz) | Karaoke Titles | Time (min) |
| 1.5 | 1 | 36 | 4.5 |
| 1.5 | 2 | 18 | 2.25 |
| 2 | 1 | 36 | 6.0 |
| 2 | 2 | 18 | 3.0 |

FIG. 5 illustrates a DOD broadcast system at 50 in accordance with one embodiment of the present invention. The DOD broadcast server 200 transmits an RF signal containing a large number of small data files (such as karaoke files) to a large number of receiving STBs 100 via a broadcast transmission medium 52. In accordance with one embodiment the transmission medium 52 is a cable television transmission medium such as that used by existing cable television providers. Unlike conventional DOD broadcast systems, all receiving STBs 100 receive all transmitted data files. A user STB must have proper authorization to view or store a selected data file.

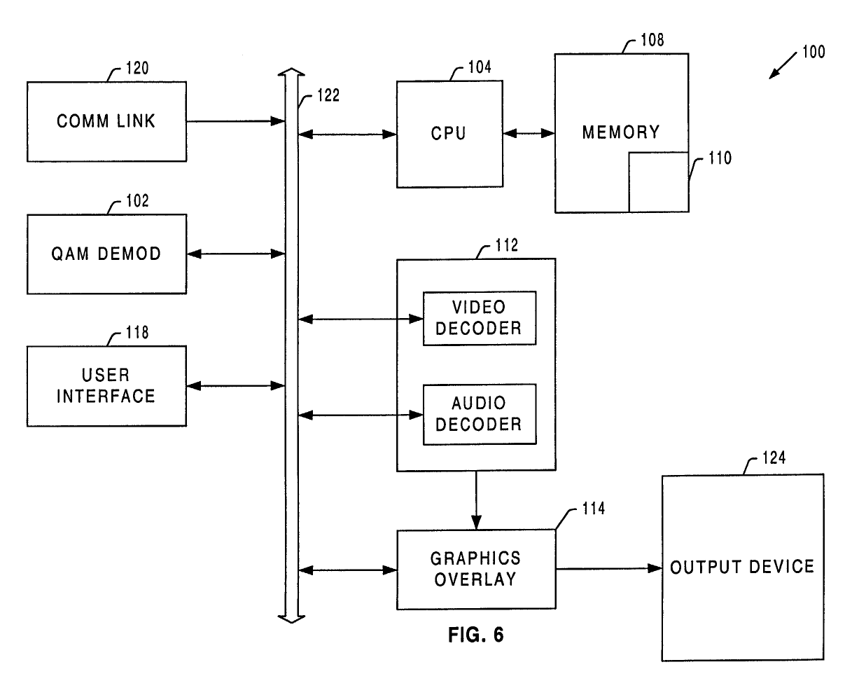

FIG. 6 illustrates a simplified operational block diagram of an intelligent STB device at 100 in accordance with one embodiment of the invention. The STB 100 comprises a QAM demodulator 102, a CPU 104, a local memory 108, a buffer memory 110, a decoder 112 having video and audio decoding capabilities, a graphics overlay module 114, a user interface 118, a communications link 120, and a fast data bus 122 coupling these devices as illustrated. The CPU 104 controls overall operation of the intelligent STB 100 in order to select data in response to a client's request, decode selected data, decompress decoded data, re-assemble decoded data, store decoded data in the local memory 108 or the buffer memory 110, and deliver stored data to the decoder 112. In an exemplary embodiment, the local memory 108 comprises both non-volatile memory (e.g., a hard drive) and secure memory (e.g., a ROM chip), and the buffer memory 110 comprises volatile memory.

In one embodiment, the QAM demodulator 102 comprises transmitter and receiver modules and one or more of the following: privacy encryption/decryption module, forward error correction decoder/encoder, tuner control, downstream and upstream processors, CPU and memory interface circuits. The QAM demodulator 102 receives modulated IF signals, samples and demodulates the signals to restore data.

In an exemplary embodiment, when access is granted, the decoder 112 decodes data blocks of selected data files into images displayable on an output device 124. The decoder 112 supports commands from a subscribing client, such as play, stop, pause, step, rewind, forward, etc. The decoder 112 provides decoded data to a graphics overlay module 114. The graphics overlay module 114 enhances displayed graphics quality by, for example, providing alpha blending or picture-in-picture capabilities. The graphics overlay module then provides an enhanced display signal to an output device 124 for display to a user. In an exemplary embodiment, the graphics overlay module 114 can be used for graphics acceleration during game playing mode, for example, when the service provider provides games-on-demand services using the system in accordance with the invention. The output device 124 may be any suitable device such as a television, computer, any appropriate display monitor, a VCR, or the like.

The user interface 118 enables user control of the STB 100, and may be any suitable device such as a remote control device, a keyboard, etc. The communications link 120 provides an additional communications connection. This may be coupled to another computer, or may be used to implement bi-directional communication. The data bus 122 is preferably a commercially available “fast” data bus suitable for performing data communications in a real time manner as required by the present invention. Suitable examples are USB, firewire, etc. Although services are broadcast to all cable television subscribers, only the DOD subscriber who has an STB 100 authorized to view a selected DOD service will be able to decode and enjoy the selected service.

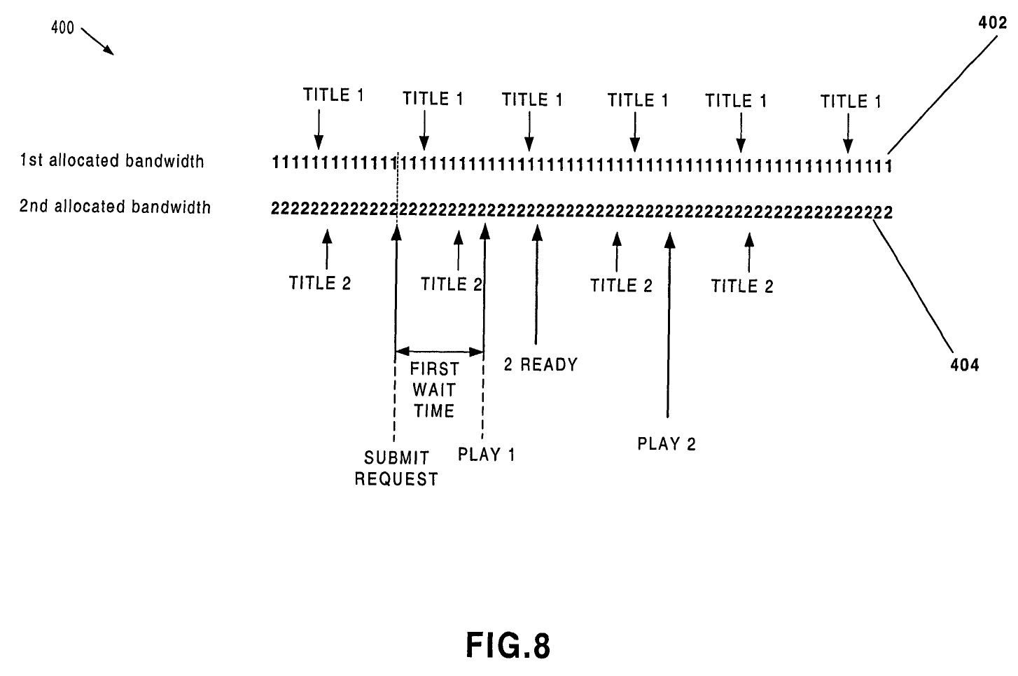

In accordance with one embodiment the intelligent STB 100 is capable of beginning to play a selected data file before it is completely downloaded. This process is discussed in more detail with reference to FIG. 8 below.

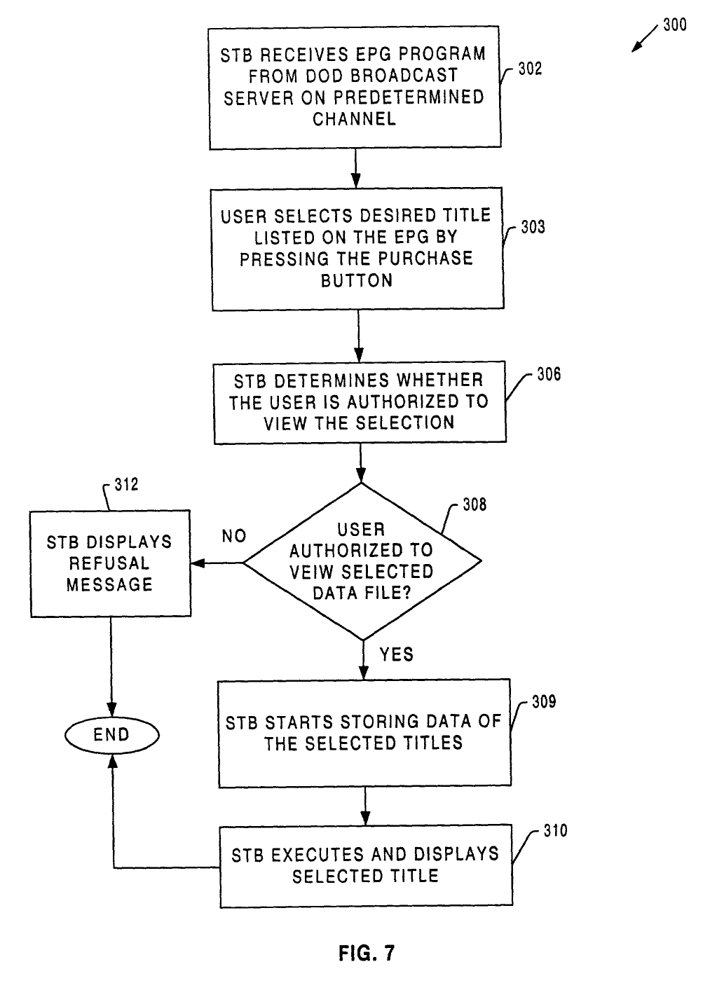

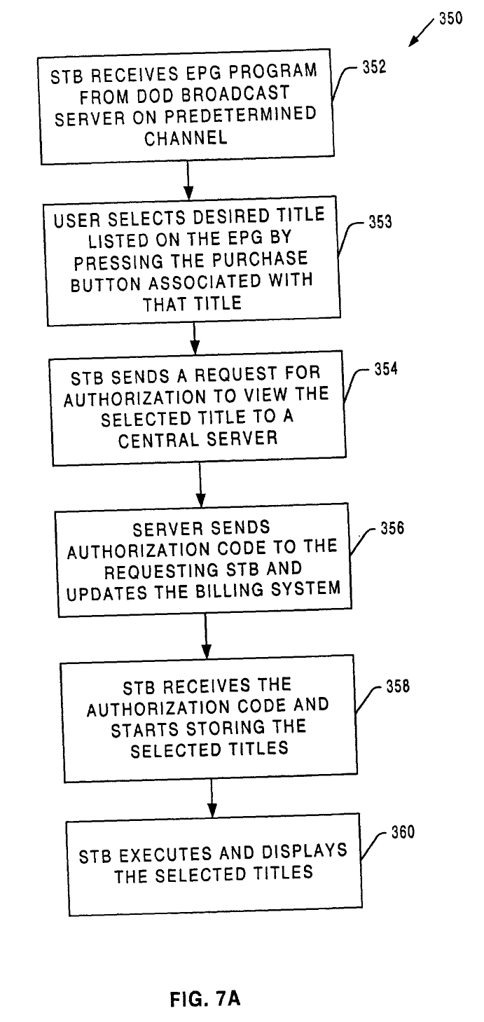

FIG. 7 illustrates a process at 300 for ordering one or more small data files (such as a karaoke files) in accordance with one embodiment of the present invention. The process 300 starts at a step 302 at which the STB 100 (FIG. 5) receives an EPG program from the DOD broadcast server 200 (FIG. 5). The EPG program lists all files available from the DOD server. In step 303 a user selects one or more titles from the EPG by pressing a button associated with each desired title. In step 306 the STB determines whether the user is authorized to view the selected data files. This may involve checking values stored on the STB 100 (FIG. 5), and comparing these values to a subscription level required for each selected data file. Such authentication methods are taught in Khoi Hoang's patent application entitled CONTROLLING DATA-ON-DEMAND CLIENT ACCESS, filed on Jul. 9, 2001, bearing application Ser. No. 09/902,503. Other methods of authenticating access to a selected data file may include bi-directional communication with the DOD server 200 (FIG. 5) or other remote site.

If the user is authorized to view the selected data file (step 308), the process proceeds to step 309. In step 309 the STB begins storing the selected files. In step 310 the STB plays the selected title for viewing by the user.

If the user is not authorized to view the selected data file (step 308), the STB displays a message refusing access at a step 312. The STB may also display a message with instructions on how the user may gain access to the refused service.

FIG. 7A illustrates an alternative bi-directional authentication process at 350 for purchasing selected DOD services. The process 350 starts at a step 352 at which the STB 100 (FIG. 5) receives an EPG program from the DOD broadcast server 200 (FIG. 5). The EPG program lists all files available from the DOD server. In step 353 a user selects a title from the EPG by pressing a purchase button associated with the desired title. In step 354 the STB sends a request for authorization to view the desired selection to the server 200 (FIG. 5). This request is transmitted via a phone modem or an uplink to the server 200.

In step 356 the server 200 sends an authorization for the selected title to the requesting STB and updates the billing system by debiting the users account. The authorization is sent either via a modem or downstream through the transmission medium 52 (FIG. 5). In step 358 the STB receives the authorization and begins storing the requested title. In step 360 the STB plays the selected title for viewing by the user.

FIG. 8 is an illustration of an exemplary broadcast of two separate small data files such as karaoke files at 400. In this example, two titles are being broadcast repeatedly over two separate bandwidths in the same channel. The first title 402 (title 1) has a playing time of 2 minutes and takes 1 minute to download. A second title 404 (title 2) has a playing time of 4 minutes and takes 2 minutes to download. Each title is repeatedly broadcast over its own allocated bandwidth simultaneously.

Once the desired titles (title 1 and title 2 for example) are selected 303 (FIG. 7) the STB 100 begins downloading both title 1 and title 2, and begins playing title 1 after 1 minute. At the time the STB 100 begins playing title 1 the STB 100 continues downloading title 2, which takes 1 additional minute. Once title 1 has completed playing the STB 100 begins playing title 2.

The STB 100 is capable of always downloading each selection in the minimum amount of time by assembling data blocks from the end of one transmission of a title and the beginning of a subsequent repeated transmission of the same title. This process is taught in Khoi Hoang's patent application entitled METHOD AND APPARATUS FOR TRANSMITTING NON-VOD SERVICES filed on Oct. 25, 2000, bearing attorney docket number 60595-301801, which is incorporated herein by reference. The STB is also capable of downloading multiple files simultaneously since each file is allocated a separate transmission bandwidth.

In a preferred embodiment the STB 100 is capable of downloading files at a bit rate greater than the bit rate at which the files can play. In this embodiment transmitted data files consist of a sequence of data blocks containing the data associated with a selected title. The STB is able to begin playing a selected title as soon as it has received the first data block of a sequence corresponding to a selected title. The STB must be able to download the data blocks of the selected title faster than the title is played for the user in order to ensure a smooth display of the title. In one embodiment the STB calculates predicted download time in order to determine when it can begin to play a data file. This calculation depends on the encoded bit rate and transmission bit rate, and buffer block size. Because the download may begin with a data block other than the first data block of a file, the wait time will be greater than the standard download time. The time an STB may begin playing a selected file can be calculated as follows:

Ts≧Tp*(Td/Tp−(NB−1)/NB) Eq. 1

Ts: time to start of play for a data file

Tp: time required to play the data file

EBR: encoded bit rate

TBR: transmission bit rate

Td: time required to download complete file (Td=file size/transmission bit rate)

NB: number of data blocks in a file (NB=data file size/buffer block size)

For example, assuming a buffer block size of 1.5 MB, a 3 minute, 45 MB file (NB=30) encoded at 2 Mb/s, with a transmission rate of 1 Mb/s, will have wait time (Ts) of approximately 186 seconds. Ts=3*(2/1−(30−1)/30)=186 seconds. In a second example, assuming a buffer block size of 1.5 MB, a 1 minute, 6 MB file (NB=4) encoded at 2 Mb/s, with a transmission speed of 1 MB/s, will have wait time (Ts) of approximately 75 seconds. Ts=1 min*(2/1−(4−1)/4)=75 seconds.

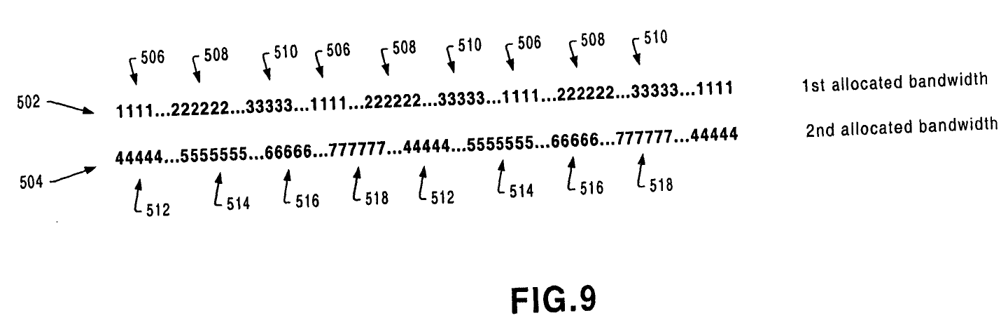

FIG. 9 illustrates an alternative method of transmitting multiple small data files on a shared bandwidth of a single transmission channel. FIG. 9 shows sequence of data blocks being transmitted on a first transmission bandwidth 502 and on a second transmission bandwidth 504 of an exemplary transmission channel. The first bandwidth 502 first transmits a first sequence of data blocks 506 corresponding to a first karaoke song, followed by a second sequence of data blocks 508 corresponding to a second karoake song, and finally data blocks of a third song 510. The bandwidth 502 repeats transmission of this sequence of three karaoke songs indefinitely. A second transmission bandwidth 504 transmits a fourth karoake song 512, a fifth karoake song 514, a sixth 516 and a seventh 518. The bandwidth 504 also repeats this sequence indefinitely. According to this aspect of the present invention, many more small data files are available on the same number of allocated channels, but a larger waiting time is required.

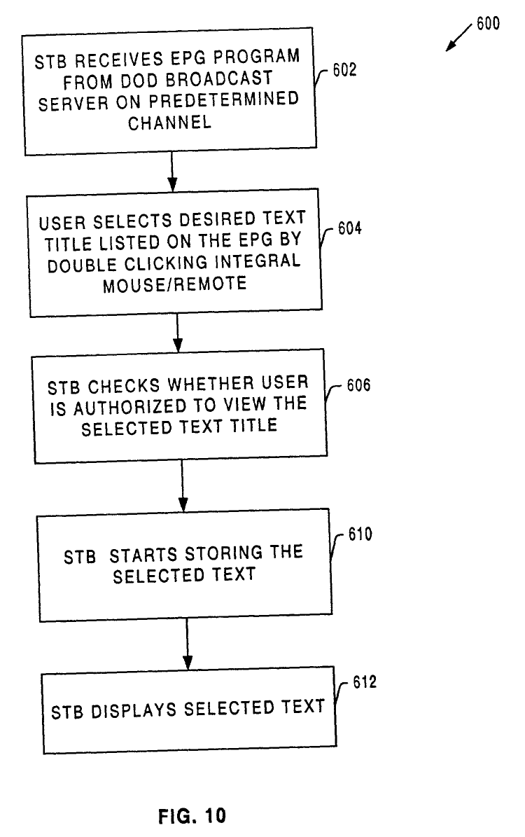

FIG. 10 illustrates a process at 600 for receiving digital text on demand (TOD) services in accordance with one embodiment of the present invention. The process 600 starts at a step 602 at which the STB 100 (FIG. 5) receives an EPG program from the DOD broadcast server 200 (FIG. 5). The EPG program lists all files (books, magazines, periodicals, etc.) available from the DOD server. File types may include movies, digital text files, music, etc. In step 604 a user selects a desired digital text file from the EPG by pressing a remote control button associated with the desired service, such a remote control may have an integral mouse or roller ball. In step 606 the STB the STB determines whether the user is authorized to view the selected digital text file. This may involve checking values stored on the STB 100 (FIG. 5), and comparing these values to a subscription level required for each selected digital text file. Such authentication methods are taught in Khoi Hoang's patent application entitled CONTROLLING DATA-ON-DEMAND CLIENT ACCESS, filed on Jul. 9, 2001, bearing application Ser. No. 09/902,503. Other methods of authenticating access to a selected digital text file may include bi-directional communication with the DOD server 200 (FIG. 5) or other remote site.

If the user is authorized to view the selected file (step 606), the process proceeds to step 610. In step 610 the STB begins storing the selected files. In step 610 the STB begins storing the requested text. In step 612 the STB displays the text to the user.

In one embodiment, as many as 4000 programs (services/channels), with as many as 250 pages/channel (total 100,000 pages), can be transmitted over a single physical channel. A greater number of programs transmitted over a single physical channel however, results in a correspondingly longer response time for accessing a desired service. Each program can contain multiple pages. The more pages a program has, the more time it would take to access the program. Programs may include page indexes describing the contents of each text page.

Text/graphic displays are also possible, though these would require a large amount of data and a corresponding increase in response time. Available formats include JPEG and bitmap, among others. A page may include text and graphic images. A page may also include hypertext language (HTML, etc).

Text files may include publications such as newspapers, magazines, books and government publication. Other information which may be available in text may include weather, transportation schedules, hotel information, stock information, shopping, breaking news, and third-party billing services.

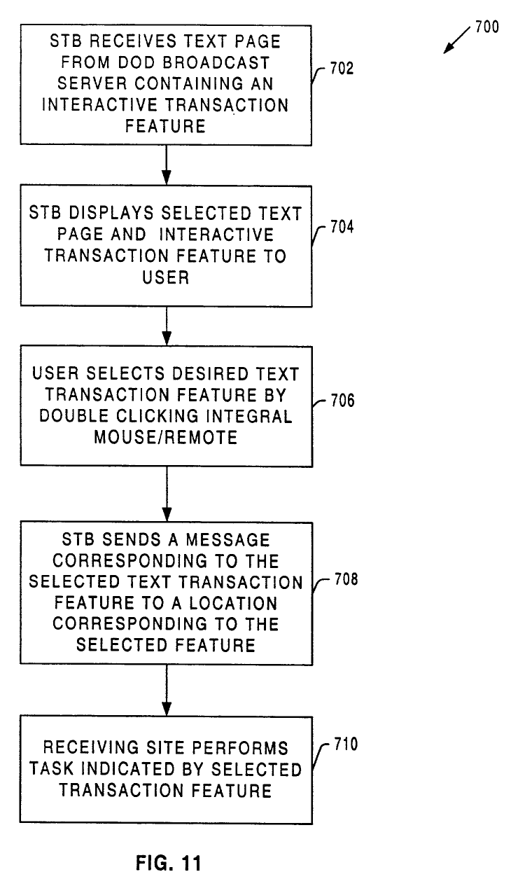

FIG. 11 illustrates a process at 700 for conducting transactions relating to a display page in accordance with the present invention. In a step 702 an STB receives a text page including one or more interactive transaction features. In step 704 the STB displays the page to the user. The transaction features are visually apparent on the displayed page. The features may be bold or of a different color, etc. Possible transaction features may include an icon for paying a bill from a third party vendor, or buying selected goods or services, or voting in a political election, etc. A home shopping channel page for example may have icons for buying selected items. A stock channel page may have buy order icons denoting various stocks, amounts or prices.

In a step 706 the user activates a selected transaction feature. In step 708 the STB sends a message corresponding to the content of the selected feature to a location corresponding to the entity corresponding to the selected feature. For example, if a user double clicked a buy icon for 100 shares of IBM at $100, the STB would send a message requesting the purchase to a stock broker web site associated with the icon via a telephone modem, local area network or other connection. If for example, a user selected a pay gas bill icon, the STB would send a message authorizing the transfer of funds to the appropriate utility.

In a step 710 the receiving site performs whatever function corresponding to the particular message sent. For example a home shopping provider would ship goods in response to an order message.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

We claim:

1. A method of transmitting a large number of small data files to a large number of customers comprising the acts of:
transmitting a plurality of data files simultaneously to a plurality of users, wherein at least one of said data files is transmitted at a rate greater than the play rate of said data file.

2. The method of claim 1 including transmitting an electronic program guide (EPG) to said plurality of users, wherein said user may select said selected data file using said electronic program guide.

3. The method of claim 1 wherein each data file is transmitted repeatedly.

4. The method of claim 3 wherein each data file has an allocated bandwidth, wherein said data files are repeatedly transmitted on a corresponding allocated bandwidth.

5. The method of claim 2 wherein an icon corresponding to each data file is displayed via the EPG such that a user may select the data file by selecting the displayed icon.

6. The method of claim 1 wherein at least one of said plurality of data files is a karoake music file including audio and visual data.

7. The method of claim 1 wherein at least one of said plurality of data files is a text file including textual information.

8. The method of claim 7 wherein said text file includes a plurality of pages, wherein at least one page contains textual information.

9. The method of claim 8 wherein at least one of said pages includes a graphic image.

10. The method of claim 9 wherein said graphic image is formatted as a JPEG image.

11. The method of claim 8 wherein at least one of said plurality of pages is an index including information indicative of the contents of at least one other page.

12. The method of claim 7 wherein a service corresponding to a transaction feature contained in said text file may be activated by said first user.

13. The method of claim 12 wherein a set top box (STB) transmits an electronic message in response to said activation of said transaction feature.

14. The method of claim 13 wherein said electronic message includes an order for the purchase of goods from a third party provider.

15. The method of claim 13 wherein said electronic message includes an order for the purchase of services from a third party provider.

16. The method of claim 13 wherein said electronic message includes an order directing funds to be deposited in an account for payment of a bill.

17. A method of downloading data files broadcast periodically, using an intelligent STB comprising:
receiving a user input indicating at least one selected data file;
initiating an authorized download of at least a first part of the selected data file broadcast during the first time interval;
displaying at least a portion of said first part of the selected data file;
retrieving a second part of the data file broadcast during the second time interval, wherein at least a portion of said first part is being displayed during said second time interval; and
displaying at least a portion of said second part of the selected data file.

18. The method of claim 17 further comprising:
retrieving additional parts of the data file broadcast during an additional time interval; and
rearranging all the parts to reconstitute the complete data file.

19. The method of claim 17 further comprising:
determining the waiting time necessary before playing said data file to assure that data blocks corresponding to said data file are received before they are scheduled to be played.

20. An apparatus for retrieving data files broadcast repetitively over at least a first time interval and a second time interval comprising:
means for receiving a file request from a user selecting at least one of the broadcast data files;
means for initiating an authorized file retrieval process to retrieve at least a first part of the data file broadcast during the first time interval;
means for displaying at least a portion of said first part of the data file during at least a portion of the second time interval;
means for retrieving a second part of the data file broadcast during the second time interval; and
means for displaying at least a portion of said second part of the data file.

21. The apparatus of claim 20 further comprising means for requesting an authorization for retrieval of the file requested.

22. The apparatus of claim 20 further comprising:
means for retrieving a third part of the data file broadcast during a third time interval; and
means for rearranging the first, second and third parts to reconstitutes the complete data file.

23. The apparatus of claim 20 wherein an EPG is received by a user STB and presented to the user.

24. The apparatus of claim 20 wherein the user STB automatically determines a download time and a play time from data transmitted with the EPG corresponding to the file selection by the user and automatically displays at least a portion of said file after a waiting period, said waiting period duration being responsive to said download time and said play time.

25. The apparatus of claim 21 wherein the user STB automatically calculates a waiting period duration responsive to said play time and said download time.

26. The apparatus of claim 22 wherein said waiting period is further responsive to the number of data blocks comprising said file.

27. An apparatus for retrieving data files broadcast repetitively over at least a first time interval and a second time interval comprising:
an input device for receiving a file request from a user selecting at least one of the broadcast data files;
a processor for initiating an authorized file retrieval process to retrieve at least a first part of the data file broadcast during the first time interval; and
an output device for displaying at least a portion of said first part of the data file during at least a portion of the second time interval;
wherein said processor is further operative for retrieving a second part of the data file broadcast during the second time interval.

28. The apparatus of claim 27 further comprising a communications port for requesting an authorization for retrieval of the file requested.

29. The apparatus of claim 27, wherein said processor is further operative for retrieving a third part of the data file broadcast during a third time interval and rearranging the first, second and third parts to reconstitute the complete data file.

30. The apparatus of claim 27 wherein an EPG is received by a user STB and presented to the user.

31. The apparatus of claim 27 wherein the user STB automatically determines a download time and a play time from data transmitted with the EPG corresponding to the file selection by the user and automatically displays at least a portion of said file after a waiting period, said waiting period duration being responsive to said download time and said play time.

32. The apparatus of claim 28 wherein the user STB automatically calculates a waiting period duration responsive to said play time and said download time.

33. The apparatus of claim 29 wherein said waiting period is further responsive to the number of data blocks comprising said file.

34. A data on demand (DOD) broadcast system for transmitting a large number of small data files comprising:
a DOD broadcast server for broadcasting a plurality of data files;
a transmission medium communicatively coupled with said DOD broadcast server;
a plurality of receivers communicatively coupled with said DOD broadcast server via said transmission medium;
wherein said DOD broadcast server repeatedly transmits a plurality of data files to said plurality of receivers via said transmission medium;
wherein said receivers are operative to enable a user to select at least one data file;
wherein said receivers are operative to perform an authorization check relating to said selected data file;
wherein said receivers are further operative to receive said selected data file; and
wherein said receivers are further operative to display a portion of said selected data file to said user.

35. A set top box apparatus for accessing small DOD data files broadcast over a wide area network comprising;
a user input device for selecting a desired data file;
a first communication link for requesting authorization to access said selected data file;
a second communications link for receiving authorization to access said selected data file;
a processor for tuning into a bandwidth corresponding to said selected data file; and
a third communications link for receiving said selected data file.

36. The apparatus of claim 35 including a display device for displaying at least a portion of said selected data file.

37. The apparatus of claim 35, wherein said processor is further operative to automatically begin displaying said selected data file when a minimum portion of said selected data file has been received.

38. The apparatus of claim 36 wherein said input device is further operative to receive user input activating a transaction feature, wherein visual data associated with said transaction feature is displayed via said display device.

39. A DOD broadcast server apparatus for transmitting a large number of small DOD data files to a large number of recipients over a wide area network comprising;
a storage server for storing data files;
a channel server for retrieving selected data files from said storage server;
a transmitter for repeatedly transmitting a first data file over an allocated bandwidth such that a receiver may access said first data file within a predetermined time period.

40. The apparatus of claim 39 wherein said time period is less than the time required to download said first data file.

41. The apparatus of claim 39, further comprising:
a service authorization processor operative to receive authorization requests from clients and to provide authorization codes to clients to view a selected data file, wherein said service authorization processor is further operative to send information indicative of said selected data file to a billing apparatus; and
wherein said billing apparatus is operative to update client billing records in response to said information.
